(19) United States
(12) Patent Application Publication
(10) Pub. No.: US 2024/0063412 A1
(43) Pub. Date: Feb. 22, 2024

(54) FUEL CELL SYSTEM AND THERMAL MANAGEMENT METHOD THEREOF

(71) Applicant: HYUNDAI MOBIS CO., LTD., Seoul (KR)

(72) Inventors: Jong Bo WON, Yongin-si (KR); Hye Su LIM, Yongin-si (KR); Sung Kyung CHOI, Yongin-si (KR)

(73) Assignee: HYUNDAI MOBIS CO., LTD., Seoul (KR)

(21) Appl. No.: 18/228,049

(22) Filed: Jul. 31, 2023

(30) Foreign Application Priority Data
Aug. 18, 2022 (KR) 10-2022-0103333

(51) Int. Cl. H01M 8/04746; H01M 8/04029; H01M 8/04223; H01M 8/04302; H01M 8/04225; H01M 8/04701; H01M 8/0432; H01M 8/04044

(52) U.S. Cl. CPC H01M 8/04768; H01M 8/04029; H01M 8/04268; H01M 8/04302; H01M 8/04225; H01M 8/04723; H01M 8/04358; H01M 8/04044; H01M 2250/20

(57) ABSTRACT

A fuel cell system includes a fuel cell stack, a valve controlling cooling water to flow to at least one of a cooling line including the fuel cell stack and a radiator and a bypass line different from the cooling line, a heater increasing a temperature of the cooling water, an ion filter removing ions in the cooling water, and a controller determining a starting method of the fuel cell based on an outside air temperature and the temperature of the cooling water at an inlet of the fuel cell stack and determining an opening angle of the valve and an operation of the heater based on the temperature of the cooling water passing through the valve and the temperature of the cooling water passing through a connection line including the ion filter and connected to the cooling line and the bypass line when the starting method is cold start.

### CROSS-REFERENCE TO RELATED APPLICATION

This application claims the benefit of priority to Korean Patent Application No. 10-2022-0103333, filed in the Korean Intellectual Property Office on Aug. 18, 2022, the entire contents of which are incorporated herein by reference.

### TECHNICAL FIELD

The present disclosure relates to a fuel cell system and a thermal management method thereof.

### BACKGROUND

Fuel cell systems may generate electric energy using fuel cell stacks. For example, when hydrogen is used as a fuel for the fuel cell stack, the fuel cell stack may be alternative to solving global environmental problems, and thus R&D on the fuel cell systems has been continuously carried out.

The fuel cell system may include a fuel cell stack that generates electrical energy, a fuel supply device that supplies a fuel (hydrogen) to the fuel cell stack, an air supply device that supplies, to the fuel cell stack, oxygen in the air, which is an oxidizing agent required for electrochemical reaction, and a thermal management system (TMS) that removes reaction heat of the fuel cell stack to the outside of the system, controls an operating temperature of the fuel cell stack, and performs a water management function.

The TMS is a type of cooling device that allows antifreeze serving as cooling water to circulate to the fuel cell stack so as to maintain an appropriate temperature (for example, 60 to 70° C.) and may include a TMS line, a reservoir in which the cooling water is stored, a pump that allows the cooling water to circulate, an ion filter that removes ions included in the cooling water, and a radiator that emits heat of the cooling water to the outside. Further, the TMS may include a heater that heats the cooling water, an air conditioning unit (for example, a heater) that heats or cools, using the cooling water, the inside of a device (for example, a vehicle) in which the fuel cell system is included, and the like. The TMS may maintain components of the vehicle as well as the fuel cell stack at an appropriate temperature.

### SUMMARY

The present disclosure has been made to solve the above-mentioned problems occurring in the prior art while advantages achieved by the prior art are maintained intact.

Thermal management of a fuel cell system is directly related to stability of a fuel cell. In particular, when cooling water is not sufficiently thawed or heated during cold start of the fuel cell, the fuel cell system may encounter an out-of-control state. In general, to secure cold startability, the fuel cell system uses a method of using antifreeze as the cooling water, a method of heating the cooling water through a heater, or the like.

An aspect of the present disclosure provides a fuel cell system that may more effectively control a flow path of the cooling water through one control valve when the fuel cell is started, and a thermal management method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell system includes a fuel cell stack, a control valve that controls cooling water to flow to at least one of a first cooling line including the fuel cell stack and a radiator and a bypass line different from the first cooling line, a heater that increases a temperature of the cooling water, an ion filter that removes ions included in the cooling water, and a controller that determines a starting method of the fuel cell based on an outside air temperature and the temperature of the cooling water at an inlet of the fuel cell stack and determines an opening angle of the control valve and an operation of the heater based on the temperature of the cooling water passing through the control valve and the temperature of the cooling water passing through a first connection line including the ion filter and connected to the first cooling line and the bypass line when the starting method is cold start.

According to an embodiment, the controller may determine the starting method as the cold start when the outside air temperature is smaller than or equal to a first temperature and the temperature of the cooling water at the inlet of the fuel cell stack is smaller than or equal to a second temperature.

According to an embodiment, the controller may control the opening angle of the control valve to a first range, control the cooling water to flow to a first path, and turn on the heater when the temperature of the cooling water passing through the control valve is smaller than a threshold temperature and the temperature of the cooling water passing through the first connection line is smaller than the threshold temperature.

According to an embodiment, the first path may include the first connection line, a second connection line including the heater, and the bypass line and may not include the first cooling line.

According to an embodiment, the controller may turn off the heater, control the opening angle of the control valve to a second range, and control the cooling water to flow to a second path when the temperature of the cooling water passing through the control valve is greater than or equal to a threshold temperature or the temperature of the cooling water passing through the first connection line is greater than or equal to the threshold temperature.

According to an embodiment, the second path includes the first connection line and the first cooling line and may not include a second connection line including the heater.

According to an embodiment, the controller may operate the fuel cell stack.

According to an embodiment, the ion filter and the control valve may include a temperature sensor that obtains the temperature of the cooling water.

According to another aspect of the present disclosure, a thermal management method of a fuel cell system includes determining a starting method of a fuel cell based on an outside air temperature and a temperature of cooling water at an inlet of a fuel cell stack, and determining an opening angle of a first valve and an operation of a heater that increases the temperature of the cooling water based on the temperature of the cooling water passing through a control valve and the temperature of the cooling water passing through a first connection line including an ion filter that removes ions included in the cooling water and connected to a first cooling line and a bypass line when the starting method is cold start, wherein the control valve controls the cooling water to flow to at least one of the first cooling line including the fuel cell stack and a radiator and the bypass line different from the first cooling line.

According to an embodiment, the determining of the starting method of the fuel cell based on the outside air temperature and the temperature of the cooling water at the inlet of the fuel cell stack may include determining the starting method as the cold start when the outside air temperature is smaller than or equal to a first temperature and the temperature of the cooling water at the inlet of the fuel cell stack is smaller than or equal to a second temperature.

According an embodiment, the determining the opening angle of the control valve and the operation of the heater that increases the temperature of the cooling water may include comparing the temperature of the cooling water passing through the control valve and the temperature of the cooling water passing through the first connection line with a threshold temperature, controlling the opening angle of the control valve to a first range, controlling the cooling water to flow to a first path, and turning on the heater when the temperature of the cooling water passing through the control valve is smaller than the threshold temperature and the temperature of the cooling water passing through the first connection line is smaller than the threshold temperature, and turning off the heater, controlling the opening angle of the control valve to a second range, and controlling the cooling water to flow to a second path when the temperature of the cooling water passing through the control valve is greater than or equal to the threshold temperature and the temperature of the cooling water passing through the first connection line is greater than or equal to the threshold temperature.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a fuel cell system according to an embodiment of the present disclosure;

FIGS. 2A and 2B are views illustrating a first cooling water flow of the fuel cell system according to the embodiment of the present disclosure;

FIG. 3 is a view illustrating a fuel cell system according to another embodiment of the present disclosure;

FIG. 4 is a view illustrating a fuel cell system according to still another various embodiments of the present disclosure;

FIGS. 5A and 5B describe a first pipe and a second pipe according to various embodiments;

FIG. 6 is a view illustrating a controller of a fuel cell system according to an embodiment disclosed in the present document;

FIG. 7A is a view illustrating an example of a first path according to the embodiment disclosed in the present document;

FIG. 7B is a view illustrating an example of a second path according to the embodiment disclosed in the present document;

FIG. 7C is a view illustrating an example of a control valve according to the embodiment disclosed in the present document;

FIG. 8 is a flowchart for describing a thermal management method of the fuel cell system according to the embodiment disclosed in the present document;

FIG. 9 is a flowchart for describing a process of determining a starting method of the fuel cell system according to the embodiment disclosed in the present document; and

FIG. 10 is a flowchart for describing a process of controlling a control valve and a heater of the fuel cell system according to the embodiment disclosed in the present document.

### DETAILED DESCRIPTION

Hereinafter, various embodiments of the present disclosure will be described with reference to the accompanying drawings. However, it should be understood that the present disclosure is not limited to specific embodiments and includes various modifications, equivalents, and/or alternatives of the embodiments of the present disclosure.

In the present disclosure, a singular form of a noun corresponding to an item may include one or more of items unless the relevant context clearly indicates otherwise. In the present disclosure, phrases such as “A or B,” “at least one of A and B,” “at least one of A or B,” “A, B, or C,” “at least one of A, B, and C,” and “at least one of A, B, or C” may include any one of the items listed together in a corresponding one of the phrases or all possible combinations thereof. Such terms as “first” and “second” or “1st” and “2nd” may be used to simply distinguish a corresponding component from another corresponding component, and does not limit the components in other aspects (for example, importance or order). When it is referenced that a component (for example, a first component) is “coupled with” or “connected with” another component (for example, a second component) with or without the term “operatively” or “communicatively”, this means that the component may be connected with the another component directly (for example, in a wired manner), wirelessly, or via a third component.

Each component (for example, a module or a program) of components described in the present disclosure may include a singular or a plurality of entities. According to various embodiments, one or more components or operations among the above-described components may be omitted or one or more other components or operations may be added. Alternatively or additionally, the plurality of components (for example, modules or programs) may be integrated into one component. In this case, the integrated component may perform one or more functions of respective components of the plurality of components in a manner that is the same as or similar to the functions performed by the corresponding component among the plurality of components before the integration. According to various embodiment, operations performed by modules, programs, or other components may be executed sequentially, parallelly, repeatedly, or heuristically, one or more of the operations may be executed in a different order or omitted, or one or more other operations may be added.

Terms “module” or “unit” used herein may include a unit implemented in hardware, software, or firmware, and may be used interchangeably with terms such as logic, a logic block, a component, or a circuit. The module may be an integrally formed component or a minimum unit or a part of the component performing one or more functions. For example, according to an embodiment, the module may be implemented in the form of an application-specific integrated circuit (ASIC).

Various embodiments of the present document may be implemented by software (for example, a program or an application) including one or more instructions stored in a storage medium (for example, a memory or) that may be read by a machine. For example, a processor of the machine may call at least one instruction among one or more instructions stored in the storage medium and may execute the instruction. This enables at least one function to be performed according to the at least one called instruction. The one or more instructions may include a code that is made by a compiler or a code that may be executed by an interpreter. The storage medium that may be read by the machine may be provided in the form of a non-transitory storage medium. Here, the “non-transitory storage medium” merely means that the storage medium is a tangible device and does not include a signal (for example, an electromagnetic wave), and with regard to the term, a case in which data is semi-permanently stored in the storage medium and a case in which data is temporarily stored in the storage medium are not distinguished from each other.

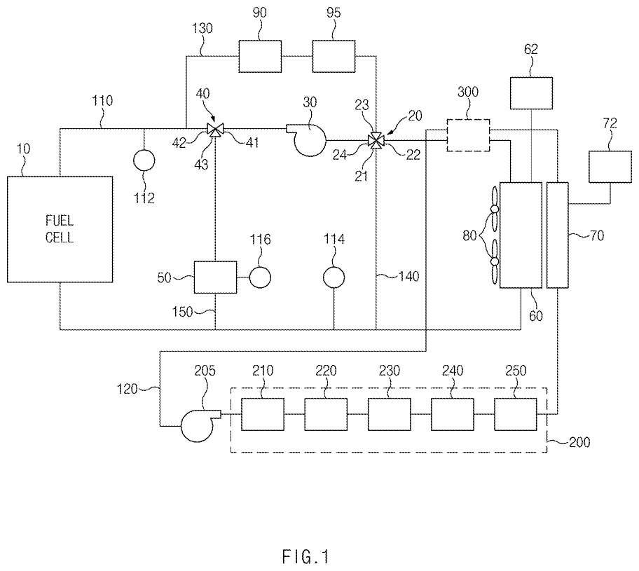

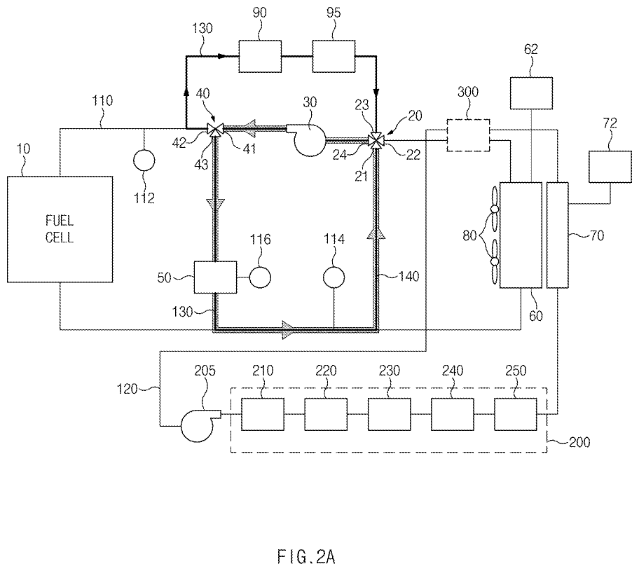

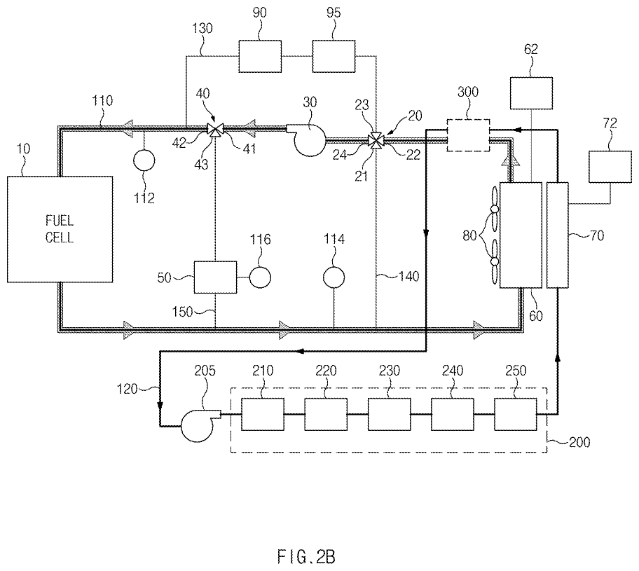

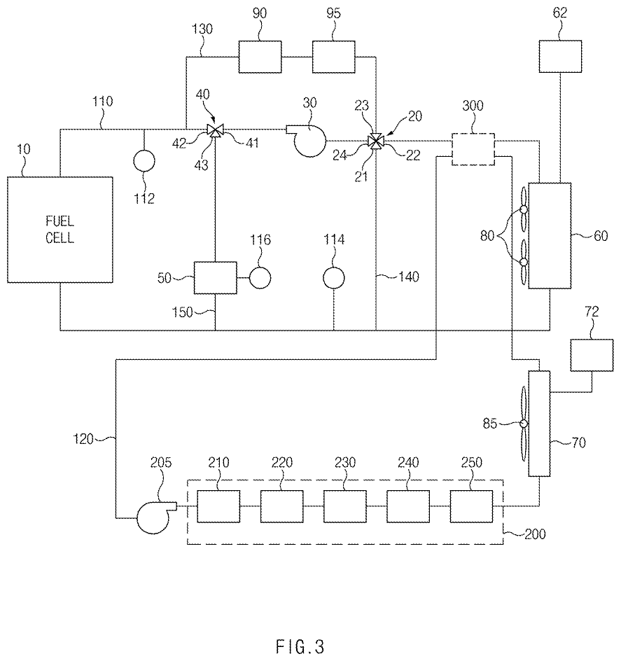

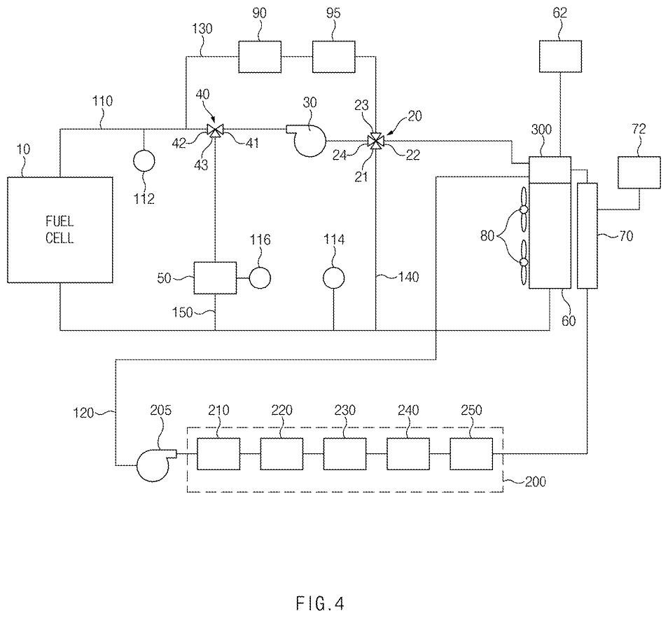

FIGS. 1 to 4 are views illustrating a fuel cell system according to various embodiments, FIG. 1 is a view illustrating a fuel cell system according to an embodiment of the present disclosure, FIGS. 2A and 2B are views illustrating a first cooling water flow of the fuel cell system according to an embodiment of the present disclosure, and FIGS. 3 and 4 are views illustrating a fuel cell system according to other embodiments.

Referring to FIG. 1, a vehicle fuel cell system may include a first cooling line 110 through which first cooling water passing through a fuel cell stack 10 of a vehicle circulates and a second cooling line 120 through which second cooling water passing through power electronic parts 200 of the vehicle circulates. In an embodiment, the fuel cell system may further include a heat exchanger 300 that exchanges heat between the first cooling water and the second cooling water, but the heat exchanger 300 may be omitted.

The fuel cell system may include a first connection line 130, a second connection line 150, and a third connection line 140 to form a heating loop (a heating circulation path or a heating loop) with the first cooling line 110 or form a cooling line with the first cooling line 110. The first cooling water may be cooled or heated while circulating through the first connection line 130, the second connection line 150, or the third connection line 140. As an example, in an initial starting state of the vehicle, to secure the cold starting capability, the first cooling line 110 may form the heating loop with the second connection line 150 and the third connection line 140 as illustrated in FIG. 2A, and during driving, to discharge heat generated by the fuel cell stack 10 to the outside, the first cooling line 110 may form a cooling loop in which the first cooling water passes through a first radiator 60 as illustrated in FIG. 2B. Although not illustrated in FIGS. 2A and 2B, a portion of the first cooling water may flow to the third connection line 140 and the other thereof may pass through the first radiator 60 according to the amount of cooling required for the fuel cell system. In another embodiment, when the temperature of outside air is as high as a specified temperature, the first cooling line 110 does not form the heating loop, and the fuel cell system may secure the starting capability through the heat of the fuel cell stack 10. The fuel cell stack 10, a first valve 20, a first pump 30, a second valve 40, and the first radiator 60 may be arranged on the first cooling line 110 through which the first cooling water circulates.

The fuel cell stack 10 (or referred to as a “fuel cell”) may be formed in a structure capable of producing electricity through an oxidation-reduction reaction of a fuel (for example, hydrogen) and an oxidizing agent (for example, air). As an example, the fuel cell stack 10 may include a membrane electrode assembly (MEA) to which catalytic electrode layers in which electrochemical reactions occur are attached on both sides with respect to a center of an electrolyte membrane through which hydrogen ions move, a gas diffusion layer (GDL) that serves to evenly distribute reactive gases and transfer generated electrical energy, a gasket and a fastening mechanism for maintaining airtightness and appropriate fastening pressure of the reactive gases and the first cooling water, and a bipolar plate that moves the reactive gases and the first cooling water.

In the fuel cell stack 10, the hydrogen as the fuel and the air (oxygen) as the oxidizing agent are supplied to an anode and a cathode of the MEA through a passage of the bipolar plate. The hydrogen may be supplied to the anode and the air may be supplied to the cathode. The hydrogen supplied to the anode is decomposed into hydrogen ions (protons) and electrons by a catalyst of electrode layers configured on both sides of the electrolyte membrane. Among them, only the hydrogen ions may be selectively transferred to the cathode through the electrolyte membrane that is a positive ion exchange membrane, and at the same time, the electrons may be transferred to the cathode through the GDL and the bipolar plate that are conductors. In the cathode, the hydrogen ions supplied through the electrolyte membrane and the electrons transferred through the bipolar plate may react with oxygen in the air supplied to the cathode by an air supply device to produce water. Due to movement of the hydrogen ions occurring in this case, a flow of the electrons through an external conducting wire may occur, and a current may be generated by the flow of the electrons.

The first valve 20 may switch a flow path of the first cooling water on the first cooling line 110 to the first radiator 60 or the fuel cell stack 10. For example, the first valve 20 may be provided on the first cooling line 110 to be positioned between the first pump 30 and the first radiator 60 and may be connected to one end of the third connection line 140 and an outlet of the first radiator 60. The first valve 20 may include various valve devices capable of selectively switching the flow path of the first cooling water to the first radiator 60 or the fuel cell stack 10. As an example, the first valve 20 may be a four-way valve or a three-way valve. In the case of the three-way valve, the first valve 20 may include a first port 21 connected to the third connection line 140, a second port 22 connected to the first cooling line 110 so that the first cooling water passing through the first radiator 60 flows thereinto, and a third port 23 connected to the first cooling line 110 so that the first cooling water flows into the first pump 30, and in the case of the four-way valve, the first valve 20 may further include a fourth port 24 connected to one end of the first connection line 130. As the first port 21 and the second port 22 of the first valve 20 are opened or closed, the flow path of the first cooling water may be switched to the first radiator 60 or the fuel cell stack 10. That is, when the first port 21 is opened and the second port 22 is blocked, the first cooling water flows into the fuel cell stack 10 without passing through the first radiator 60, and in contrast, when the second port 22 is opened and the first port 21 is blocked, the first cooling water may flow into the fuel cell stack 10 after passing through the first radiator 60. According to an opening amount of the first valve 20, a portion of the first cooling water may pass through the first radiator 60 and the other portion thereof may flow along the third connection line 140.

The first connection line 130 may form the heating loop with the first cooling line 110 to heat an air conditioning unit (HVAC UNIT) 90. As an example, the first connection line 130 may form a loop that heats a heater (not illustrated) of the air conditioning unit 90. One end of the first connection line 130 may be connected to the first cooling line 110 between a first point (a point at which one end of the second connection line 150 is connected to the first cooling line 110) and an inlet of the fuel cell stack 10, and a portion of the first cooling water may circulate through the first connection line 130. The other end of the first connection line 130 may be connected to the first cooling line 110 between the first pump 30 and a second point (a point at which the other end of the second connection line 150 is connected to the first cooling line 110).

The first connection line 130 may be provided with an ion filter 95 that filters out ions of the first cooling water passing through the air conditioning unit 90. When electrical conductivity of the first cooling water increases due to corrosion or exudation of a system, electricity flows to the first cooling water to cause a short circuit of the fuel cell stack 10 or cause a current to flow toward the first cooling water, and thus the first cooling water should maintain low electrical conductivity. The ion filter 95 may be set to remove the ions included in the first cooling water so that the electrical conductivity of the first cooling water may be maintained at a predetermined level or less. In this way, during cold starting during which the supply of the first cooling water flowing to the fuel cell stack 10 is blocked (a second port 42 of the second valve 40 is blocked), the first cooling water circulates (passes through a temperature increasing loop) via a heater 50 of the second connection line 150, and at the same time, circulates along the first connection line 130. Accordingly, even in the cold starting, the filtering by the ion filter 95 provided in the first connection line 130 may be performed (the ions included in the first cooling water may be removed). Thus, the electrical conductivity of the first cooling water flowing into the fuel cell stack 10 immediately after the cold starting may be maintained at a certain level or less.

The second valve 40 may switch the flow path of the first cooling water on the first cooling line 110 to the second connection line 150 in which the heater 50 is disposed or the fuel cell stack 10. For example, the second valve 40 may be connected to one end of the first pump 30, one end of the second connection line 150, and one end of the fuel cell stack 10 on the first cooling line 110. The second valve 40 may include various valve devices capable of selectively switching the flow path of the first cooling water. As an example, the second valve 40 may be a three-way valve. In this case, the second valve 40 may include a first port 41 connected to the first cooling line 110 so that the first cooling water pumped by the first pump 30 flows thereinto, the second port 42 connected to the first cooling line 110 so that the first cooling water passing through the second valve 40 flows into the fuel cell stack 10, and a third port 43 connected to one end of the second connection line 150. As the second port 42 and the third port 43 of the second valve 40 are opened or closed, the flow path of the first cooling water may be switched to the heater 50 of the second connection line 150 or the fuel cell stack 10. That is, when the second port 42 is opened and the third port 43 is blocked, the first cooling water flows into the fuel cell stack 10, and in contrast, when the third port 43 is opened and the second port 42 is blocked, the first cooling water may flow into the heater 50 through the second connection line 150.

The second connection line 150 may form the heating loop (a heating circulation path) with the first cooling line 110 to heat the first cooling water. For example, the first cooling water flowing along the second connection line 150 may be heated while passing through the heater 50 installed in the second connection line 150. One end of the second connection line 150 may be connected to the first cooling line 110 at a first point positioned between an outlet of the first pump 30 and the fuel cell stack 10, and the other end of the second connection line 150 may be connected to the first cooling line 110 at a second point positioned between an inlet of the first pump 30 and the fuel cell stack 10. Here, the inlet of the first pump 30 may be defined as an inlet through which the first cooling water flows into the first pump 30. Further, the outlet of the first pump 30 may be defined as an output through which the first cooling water passing through the first pump 30 is discharged. Further, a section between the outlet of the first pump 30 and the fuel cell stack 10 may be defined as a section through which the first cooling water discharged from the first pump 30 flows to a first cooling water inlet (not illustrated) of the fuel cell stack 10. Further, a section between the inlet of the first pump 30 and the fuel cell stack 10 may be defined as a section through which the first cooling water discharged from a cooling water outlet (not illustrated) of the fuel cell stack 10 flows to the inlet of the first pump 30.

The first pump 30 may be set such that the first cooling water forcibly flows. The first pump 30 may include various devices capable of pumping the first cooling water, and the type and number of the first pump 30 are not limited to the present document.

The third connection line 140 may form a cooling loop with the first cooling line 110 to cool the first cooling water. As an example, one end of the third connection line 140 may be connected to the first cooling line 110 between the first pump 30 and the first radiator 60, and the other end of the third connection line 140 may be connected to the first cooling line 110 between the cooling water outlet of the fuel cell stack 10 and the first radiator 60.

The first radiator 60 may be set to cool the first cooling water. The first radiator 60 may be formed in various structures capable of cooling the first cooling water, and the present disclosure is not restricted or limited by the type and structure of the first radiator 60. The first radiator 60 may be connected to a first reservoir 62 in which the first cooling water is stored.

The fuel cell system may include a first temperature sensor 112 that measures the temperature of the first cooling water between the fuel cell stack 10 and the first point (the second valve 40), a second temperature sensor 114 that measures the temperature of the first cooling water between the other end of the second connection line 150 and the first pump 30, and a third temperature sensor 116 that measures the temperature of the first cooling water in the heater 50. The fuel cell system may control an inflow rate of the first cooling water flowing into the fuel cell stack 10 based on the temperatures measured by the first temperature sensor 112, the second temperature sensor 114, and the third temperature sensor 116. As an example, when the measured temperature of the first cooling water circulating along the first cooling line 110 is lower than a predetermined target temperature, the inflow rate of the first cooling water may be controlled to become lower than a preset inflow rate. In this way, when the measured temperature of the first cooling water is low, the inflow rate of the first cooling water flowing into the fuel cell stack 10 is controlled to be low, and thus thermal shock and performance degradation due to a difference between the temperature of the first cooling water staying inside the fuel cell stack 10 and the temperature of the first cooling water flowing into the fuel cell stack 10 may be minimized.

The second cooling line 120 may pass through the power electronic part 200 of the vehicle, and the second cooling water may circulate along the second cooling line 120. Here, the power electronic part 200 of the vehicle may be understood as a component using power of the vehicle as an energy source, and the present disclosure is not restricted or limited by the type and number of the power electronic part 200. For example, the power electronic part 200 may include at least one of a bi-directional high voltage direct current (DC)-DC converter (BHDC) 210 provided between the fuel cell stack 10 and a high-voltage battery (not illustrated) of the vehicle, a blower pump control unit (BPCU) 220 that controls a blower (not illustrated) for supplying outside air for driving the fuel cell stack 10, a low-voltage DC-DC converter (LDC) 230 that converts DC high voltage supplied from the high-voltage battery into DC low voltage, an air compressor (ACP) 240 for compressing air supplied to the fuel cell stack 10, and an air cooler 250. Although not illustrated in FIGS. 1 to 4, the power electronic part 200 may further include a DC-DC buck/boost converter.

A second pump 205 for allowing the second cooling water to forcibly flow may be disposed on the second cooling line 120. The second pump 205 may include a pumping device capable of pumping the second cooling water, and the type and characteristics of the second pump 205 are not restricted or limited.

A second radiator 70 for cooling the second cooling water may be disposed on the second cooling line 120. The second radiator 70 may be formed in various structures capable of cooling the second cooling water, and the type and structure of the second radiator 70 are not restricted or limited. The second radiator 70 may be connected to a second reservoir 72 in which the second cooling water is stored.

In an embodiment, as illustrated in FIG. 1, the first radiator 60 and the second radiator 70 may be simultaneously cooled by one cooling fan 80. As an example, the first radiator 60 and the second radiator 70 may be arranged side by side, and the cooling fan 80 may be set to blow outside air to the first radiator 60 and the second radiator 70. As the first radiator 60 and the second radiator 70 are simultaneously cooled by the one cooling fan 80, the structure of the fuel cell system may be simplified, degree of freedom of design and space utilization may be improved, and power consumption for cooling the first radiator 60 and the second radiator 70 may be minimized.

In another embodiment, as illustrated in FIG. 3, the first cooling fan 80 for cooling the first radiator 60 and a second cooling fan 85 for cooling the second radiator 70 may be arranged separately from each other. In this case, when the fuel cell system controls the number of rotations of the first cooling fan 80, a parameter related to a thermal load of the power electronic part 200 may be excluded. Although embodiments described below are based on the structure of the fuel cell system of FIG. 1, the same principle may be applied to the structure of the fuel cell system of FIG. 3.

Referring back to FIG. 1, the heat exchanger 300 may be set to exchange the heat between the first cooling water and the second cooling water. When the heat exchanger 300 is included, the first cooling line 110 and the second cooling line 120 may constitute a thermal management system (TMS) line through which the first cooling water and the second cooling water may flow while heat is exchanged therebetween, and in this case, the first cooling water or the second cooling water may be used as a cooling medium or a heat medium on the TMS line. For example, since the temperature of the second cooling water for cooling the power electronic part is relatively lower than the temperature of the first cooling water for cooling the fuel cell stack 10, the fuel cell system may lower the temperature of the first cooling water without increasing the capacities of the first radiator 60 and the cooling fan 80 by exchanging the heat between the first cooling water and the second cooling water, cooling efficiency of the fuel cell stack 10 may be improved, and safety and reliability may be improved. Further, since the fuel cell system may lower the temperature of the first cooling water while a vehicle (for example, a construction machinery) that cannot use a driving wind is stopped, high-output operation of the fuel cell stack 10 may be secured, and safety and durability may be improved.

In an embodiment, the heat exchanger 300 may be connected to the first cooling line 110 between the outlet of the first radiator 60 and the fuel cell stack 10, and the second cooling line 120 may connect the outlet of the second radiator 70 and the power electronic part to pass through the heat exchanger 300. For example, the first cooling water may flow along the heat exchanger 300 connected to the first cooling line 110, and the second cooling line 120 may pass through an inside of the heat exchanger 300 so that the second cooling line 120 is exposed to the first cooling water (for example, the first cooling water flows along a circumference of the second cooling line 120). In this way, the fuel cell system may lower the temperature of the first cooling water flowing into the fuel cell stack 10 by exchanging the heat between the first cooling water and the second cooling water. A first temperature of the first cooling water passing through the first radiator 60 may be formed to be higher than a second temperature of the second cooling water passing through the second radiator 70, and a third temperature of the first cooling water passing through the heat exchanger 300 may be formed to be lower than the first temperature. As an example, the first temperature of the first cooling water may be formed to be higher than the second temperature of the second cooling water by 10° C., and the third temperature of the first cooling water passing through the heat exchanger 300 (exchanging heat with the second cooling water) may be formed to be lower than the first temperature by 1° C.

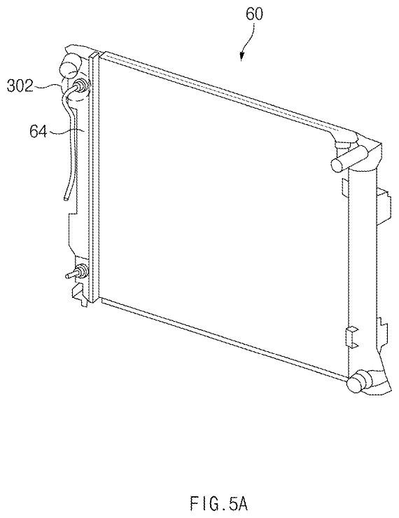

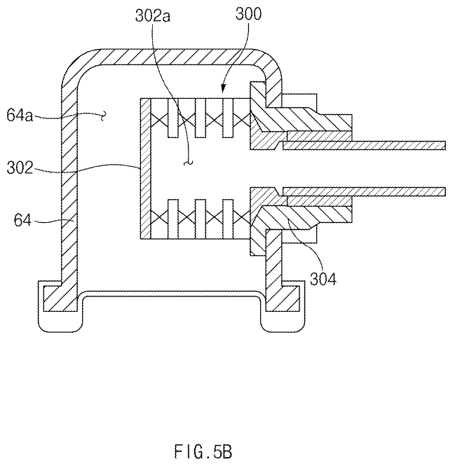

The heat exchanger 300 according to FIGS. 1 to 3 may be disposed separately from the first radiator 60, but the heat exchanger 300 according to another embodiment may be directly connected to the first radiator 60 as illustrated in FIG. 4. For example, the heat exchanger 300 may be connected to a designated position (an upper left end) of the first radiator 60, but the present disclosure is not limited thereto. When the heat exchanger 300 is connected to the upper left end of the first radiator 60, the first radiator 60 and the heat exchanger 300 may be implemented as illustrated in FIGS. 5A and 5B.

FIGS. 5A and 5B describe a first pipe and a second pipe according to various embodiments.

Referring to FIGS. 5A and 5B, the first radiator 60 may include a first pipe 64 forming a first flow path 64a through which the first cooling water flows, the heat exchanger 300 may include a second pipe 302 provided to exchange heat with the first cooling water inside the first flow path 64a, and the second cooling water may flow along the second pipe 302 and exchange heat with the first cooling water in the first flow path 64a. The second pipe 302 may form a second flow path 302a through which the second cooling water flows, and at least a portion of the second pipe 302 may be exposed to the first cooling water inside the first flow path 64a. The shape and structure of the second pipe 302 may be variously changed according to required conditions and design specifications, and the present disclosure is not restricted or limited by the shape and structure of the second pipe 302. According to an embodiment, to increase a cooling effect of the first cooling water, a heat dissipation fin for increasing a contact area on an outer surface of the second pipe 302 exposed to the first cooling water may be formed. According to an embodiment, a sealing member 304 (for example, rubber or silicone) may be provided between the first pipe 64 and the second pipe 302. In this way, as the sealing member 304 is provided between the first pipe 64 and the second pipe 302, a sealed state of the first flow path 64a may be more stably maintained.

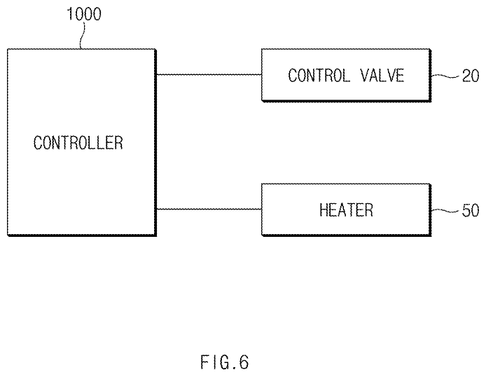

FIG. 6 is a view illustrating a controller of a fuel cell system according to an embodiment disclosed in the present document.

Referring to FIG. 6, a controller 1000 may control the control valve 20 and the heater 50.

According to the embodiment, a fuel cell system 1 may include the control valve 20, the heater 50, and the controller 1000.

According to the embodiment, the control valve 20 may control the cooling water to flow to at least one of the first cooling line 110 including the fuel cell stack 10 and the radiator 60 and a bypass line 140 different from the first cooling line 110. Here, the cooling water, the radiator, and the bypass line may be substantially the same as the first cooling water, the first radiator 60, and the third connection line 140. Further, the bypass line 140 may include a line not passing through the radiator 60. The control valve 20 may change the flow path of the cooling water according to a starting method of the fuel cell system 1 and the temperature of the cooling water.

According to the embodiment, the control valve 20 may be an integrated coolant temperature control valve (ICTV) in which the first valve and the second valve illustrated in FIGS. 1 to 4 are integrated and integrally formed. For example, the control valve 20 may control the cooling water flowing into the pump through an opening to flow to the first cooling line 110 and/or the bypass line 140 or may control the cooling water pumped by the pump to flow to the first cooling line or the second connection line 150.

According to the embodiment, the heater 50 may heat the cooling water to increase the temperature of the cooling water, and the ion filter 95 may remove ions included in the cooling water.

According to the embodiment, the controller 1000 may be a hardware device such as a processor, a micro processor unit (MPU), a micro controller unit (MCU), a central processing unit (CPU), and an electronic controller unit (ECU) or a program implemented by the processor. The controller 1000 may be connected to respective components of a hydrogen discharge system of the fuel cell to perform overall functions related to management and operation of the fuel cell stack. As an example, the controller 1000 may be a fuel cell control unit (FCU) that controls the overall functions of the fuel cell system.

According to the embodiment, the controller 1000 may communicate with the respective components, for example, the control valve 20, the heater 50, and the like, constituting the fuel cell system 1 by wire or wirelessly, and may perform the communication based on, for example, controller area network (CAN) communication.

According to the embodiment, the controller 1000 may determine a starting method of the fuel cell based on the outside air temperature and the temperature of the cooling water at the inlet of the fuel cell stack 10. The outside air temperature may refer to a temperature outside the fuel cell system 1, and the starting method may include a cold start and a normal start. The cold start may refer to a start method in which, when the temperature of the cooling water of the fuel cell system 1 is low, the cooling water is quickly heated before supplied to the fuel cell stack 10. According to the embodiment, the fuel cell system 1 may include a temperature sensor for measuring the outside air temperature.

According to the embodiment, the controller 1000 may determine the starting method as the cold start when all conditions are satisfied in which the outside air temperature is smaller than or equal to the first temperature and the temperature of the cooling water at the inlet of the fuel cell stack 10 is smaller than or equal to the second temperature. For example, the first temperature may be 10 degrees, and the second temperature may be 0 degree, but this is merely an example, and the present disclosure is not limited thereto. In this case, since the temperature of the fuel cell system 1 is lowered by the outside air temperature, the controller 1000 may determine the starting method as the cold start in which the cooling water is heated and the heated cooling water is supplied to the fuel cell stack 10 for safe operation of the fuel cell system 1.

According to the embodiment, when the starting method is the cold start, the controller 1000 may determine an opening degree of the control valve 20 and an operation of the heater 50 based on the temperature of the cooling water passing through the control valve 20 and the temperature of the cooling water passing through the first connection line 130. Here, the first connection line 130 may include a line including the ion filter 95 and connected to the first cooling line 110 and the bypass line 140. The controller 1000 may control the operation of the heater 50 according to whether the cooling water is sufficiently heated during the cold start and may control the opening degree of the control valve 20 to change the flow path of the cooling water. According to the embodiment, when the temperature of the cooling water passing through the control valve 20 is less than a threshold temperature, and when the temperature of the cooling water passing through the first connection line 130 is less than the threshold temperature, the controller 1000 may control the opening angle of the control valve 20 to be in a first range to control the cooling water to flow to a first path and control the heater 50 to be turned on. When it is determined that the temperature of the cooling water inside the fuel cell system 1 is low, the controller 1000 may control the cooling water to pass through the heater 50 so as to induce an increase in the temperature of the cooling water and block the cooling water from flowing to the fuel cell stack 10. In this case, the temperature of the cooling water passing through the first connection line 130 may refer to the temperature of the cooling water at a time point when the cooling water passes through the ion filter 95. To this end, the ion filter 95 may include a temperature sensor for acquiring the temperature of the cooling water. By this control, the controller 1000 may induce a sufficient increase in the temperature of the cooling water during the cold start and prevent failure or damage of the fuel cell stack 10 due to a low temperature. In particular, the controller 1000 may control the flow path of the cooling water not based on the temperature of the cooling water at the inlet of the fuel cell stack 10 but based on the temperature of the cooling water at the control valve 20, may accurately and preemptively block the cooling water from flowing to the fuel cell stack 10 when the temperature of the cooling water is lower than the threshold temperature, and thus may more effectively protect the fuel cell stack 10.

The first range may be expressed in units of degrees or radians, and may have, for example, a range between 0 degrees and 180 degrees. As an example, the controller 1000 may control the opening angle of the control valve 20 to a range of θ₁˜θ₂ (θ₁<θ₂) and thus control the cooling water not to flow to the first cooling line 110 including the radiator 60 but to flow to only the bypass line 140 when the cooling water passes through the control valve 20.

The threshold temperature may be set based on a type, a vehicle model, performance, or the like of the fuel cell system 1. For example, when the fuel cell stack 10 exhibits optimal performance when maintained at an angle of A, the threshold temperature may be set in a range of an angle of A-5 to the angle of A.

According to the embodiment, when the temperature of the cooling water passing through the control valve 20 is greater than or equal to the threshold temperature or when the temperature of the cooling water passing through the first connection line 130 is greater than or equal to the threshold temperature, the controller 1000 may turn off the heater 50 and control the opening degree of the control valve 20 to be in a second range so that the cooling water flows to a second path.

When it is determined that the temperature of the cooling water is sufficient due to the increase in the temperature of the cooling water, the controller 1000 may stop the operation of the heater 50, may control the flow path of the cooling water to the second path so that the cooling water flows to the fuel cell stack 10, and thus may increase the temperature of the fuel cell stack 10. After the controller 1000 turns off the heater 50 and controls the cooling water to flow through the second path, when the temperature of the cooling water passing through the control valve 20 is less than the threshold temperature and the temperature of the cooling water passing through the first connection line 130 is less than the threshold temperature again, the controller 1000 may turn on the heater 50, control the cooling water to flow through the first path, and thus maintain the temperatures of the cooling water and the fuel cell stack 10 through repeated control.

The second range may be expressed in units of degrees or radians, and may have, for example, a range between 0 degrees and 180 degrees. As an example, the controller 1000 may control the opening angle of the control valve 20 to a range of θ₂˜θ₃ (θ₂<θ₃), and thus control the cooling water to flow to the first cooling line 110 including the radiator 60 when the cooling water passes through the control valve 20. In the first range and the second range, a relationship between θ₁, θ₂, θ₃ may be θ₃<θ₂<θ₁.

According to the embodiment, the controller 1000 may control the cooling water to flow through the second path and then operate the fuel cell stack 10. After controlling the temperature of the cooling water to sufficiently increase and the cooling water to flow to the fuel cell stack 10, the controller 1000 may operate the fuel cell stack 10, thereby preventing failure or damage of the fuel cell stack 10 and increasing power consumption efficiency. In this case, the controller 1000 may control the cooling water to flow to the second path so as to heat the fuel cell stack 10 and then may operate the fuel cell stack 10 after a predetermined period of time has elapsed.

According to the embodiment, the controller 1000 may further control the number of rotations of a pump during the cold start. The pump may be substantially the same as the first pump 30 illustrated in FIGS. 1 to 4. The controller 1000 may further control the number of rotations of the pump to effectively control the temperatures of the cooling water and the fuel cell stack 10 during the cold start.

According to the embodiment, the cooling water of the fuel cell system 1 may pass through the first connection line 130 including the ion filter 95 regardless of the opening degree of the control valve 20. Therefore, the fuel cell system 1 may filter out ions (remove ions contained in the cooling water) by the ion filter 95 even during the cold start, and accordingly, the electrical conductivity of the cooling water flowing into the fuel cell stack 10 immediately after the cold start may be maintained at a certain level or less.

According to the embodiment, each of the ion filter 95 and the control valve 20 may include a temperature sensor for acquiring the temperature of the cooling water. The respective temperature sensors may be formed integrally with the ion filter 95 and the control valve 20 or famed as separate components.

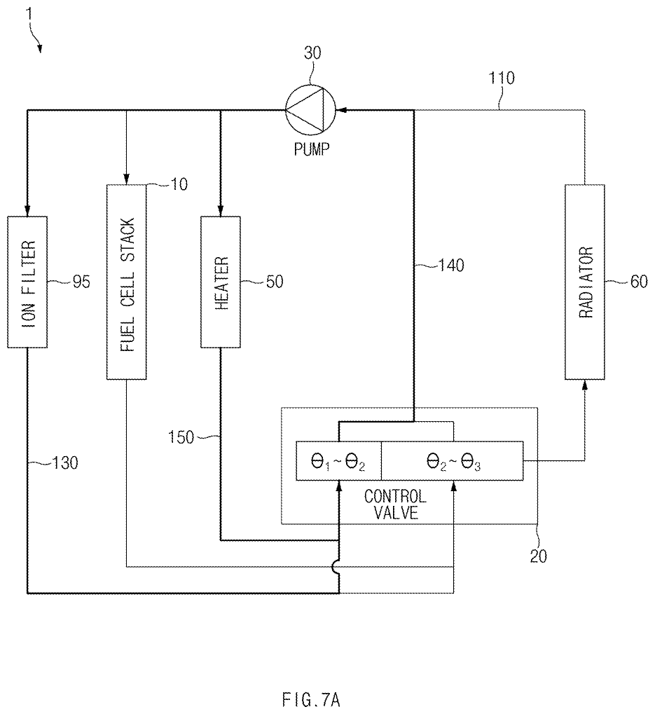

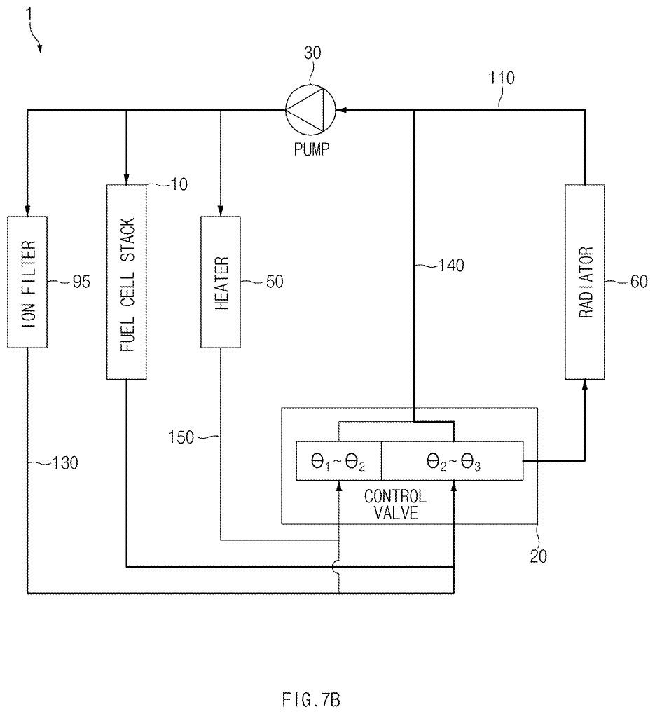

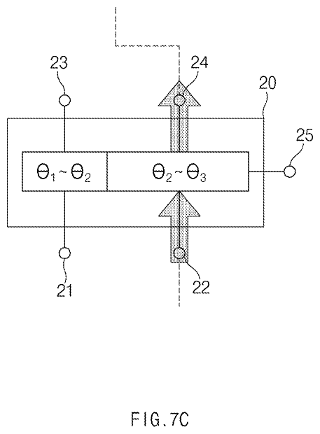

FIG. 7A is a view illustrating an example of the first path according to the embodiment disclosed in the present document, and FIG. 7B is a view illustrating an example of the second path according to the embodiment disclosed in the present document. Further, FIG. 7C is a view illustrating an example of the control valve according to the embodiment disclosed in the present document.

Referring to FIGS. 7A to 7C, the fuel cell system 1 may control the control valve 20 based on the temperature of the cooling water during the cold start to change the flow path of the cooling water.

According to the embodiment, the first path may include the first connection line 130, the second connection line 150, and the bypass line 140 and may not include the first cooling line 110. As an example, the first path may include the flow path of the cooling water for increasing the temperature of the cooling water during the cold start of the fuel cell system 1.

According to the embodiment, the second path may include the first connection line 130 and the first cooling line 110 and may not include the second connection line 150. When it is determined that the temperature of the cooling water sufficiently increases during the cold start, the controller 1000 may control the flow path of the cooling water to the second path so as to supply the cooling water to the fuel cell stack 10. As an example, the second path may include the flow path of the cooling water when the fuel cell stack 10 operates.

According to the embodiment, the control valve 20 may be a five-way valve. As an example, the control valve 20 may include the first port 21 and the second port 22 through which the cooling water flows and may include the third port 23, the fourth port 24, and a fifth port 25 through which the cooling water flowing through the first port 21 or the second port 22 is discharged. Here, the opening angle of the valve may be adjusted between a first value θ₁ and a second value θ₂ through the first port 21 and the third port 23. Meanwhile, the opening angle of the valve may be adjusted between the second value θ₂ and a third value θ₃ through the second port 22, the fourth port 24, and the fifth port 25.

The first port 21 may be connected to the first connection line 130 passing through the ion filter 95 and the second connection line 150 passing through the heater 50, and when the first port 21 is opened, the cooling water passing through the first connection line 130 and the second connection line 150 may flow thereinto.

The second port 22 may be connected to the first cooling line 110 passing through the fuel cell stack 10 and the first connection line 130 passing through the ion filter 95, and when the second port 22 is opened, the cooling water passing through the first cooling line 110 and the first connection line 130 may flow thereinto. Here, the cooling water passing through the ion filter 95 may flow into the first port 21 or the second port 22 according to opening or closing states of the first port 21 and the second port 22.

The third port 23 and the fourth port 24 are connected to the bypass line 140 through which the cooling water flows to the inlet of the pump 30 without passing through the radiator 60. As an example, the third port 23 may be opened together when the first port 21 is opened and allow the cooling water introduced through the first port 21 to be discharged to the bypass line 140. The fourth port 24 may be opened when the second port 22 is opened and allow a portion or the entirety of the cooling water introduced through the second port 22 to be discharged to the bypass line 140.

The fifth port 25 may be connected to the first cooling line 110 passing through the radiator 60 and discharge the cooling water to the first cooling line 110 when the fifth port 25 is opened. The fifth port 25 may be opened when the second port 22 is opened and allow a portion or the entirety of the cooling water introduced through the second port 22 to be discharged to the first cooling line 110.

The cooling water discharged through the fifth port 25 may flow along the first cooling line 110, may be cooled through the radiator 60, and may flow into the pump 30.

Opening or closing states and opening angles of the first to fifth ports 21 to 25 of the control valve 20 may be controlled by the controller 1000. The controller 1000 may determine the flow path of the cooling water in the first cooling line 110, the first connection line 130, the second connection line 150, and the bypass line 140 illustrated in FIGS. 7A and 7B and may control valve opening or closing states and the opening angles of the respective ports provided in the control valve 20 according to the determined flow path of the cooling water.

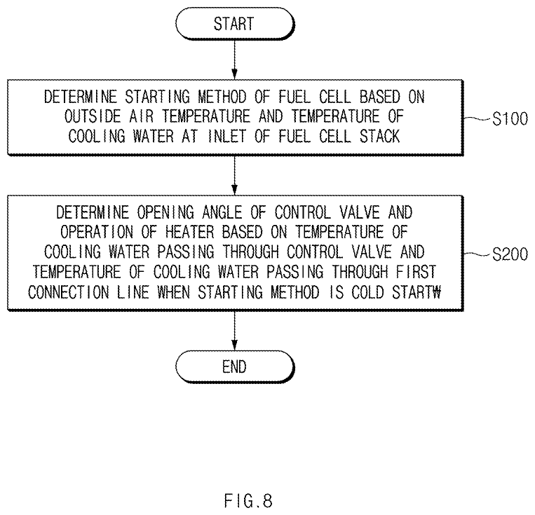

FIG. 8 is a flowchart for describing a thermal management method of the fuel cell system according to the embodiment disclosed in the present document.

Referring to FIG. 8, the thermal management method of the fuel cell system may include operation S100 of determining a starting method of a fuel cell based on the outside air temperature and a temperature of cooling water at an inlet of a fuel cell stack and operation S200 of determining an opening angle of a control valve and an operation of a heater based on the temperature of the cooling water passing through the control valve and the temperature of the cooling water passing through a first connection line when the starting method is cold start.

In operation S100, the controller 1000 may determine the starting method of the fuel cell based on the outside air temperature and the temperature of the cooling water at the inlet of the fuel cell stack 10. In this case, the starting method of the fuel cell may include cold start and normal start.

In operation S200, when the starting method of the fuel cell is the cold start, the controller 1000 may determine the opening degree of the control valve 20 and the operation of the heater 50 based on the temperature of the cooling water passing through the control valve 20 and the temperature of the cooling water passing through the first connection line 130. In this case, the controller 1000 may further control the number of rotations of the pump.

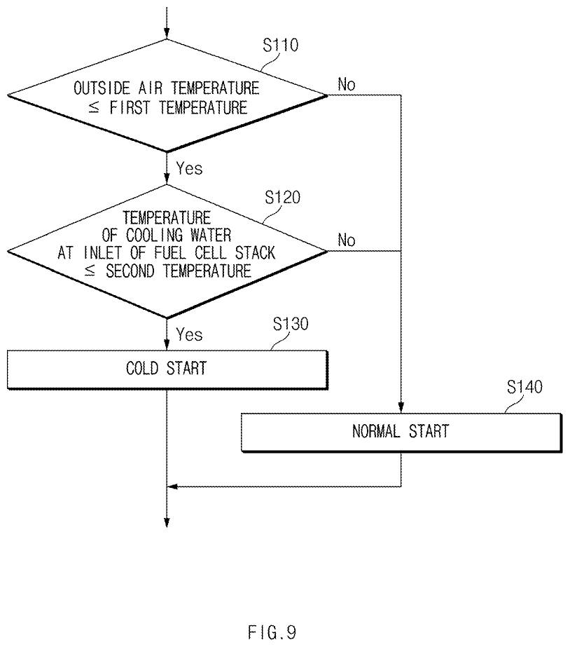

FIG. 9 is a flowchart for describing a process of determining a starting method of the fuel cell system according to the embodiment disclosed in the present document.

Referring to FIG. 9, the fuel cell system 1 may determine the starting method based on the outside air temperature and the temperature of the cooling water at the inlet of the fuel cell stack 10.

In operation S110, the controller 1000 may compare the outside air temperature and the first temperature. The fuel cell system 1 may proceed to operation S120 when the outside air temperature is lower than or equal to the first temperature (S110-Yes). The fuel cell system 1 may proceed to operation S140 when the outside air temperature exceeds the first temperature (S110-No).

In operation S120, the controller 1000 may compare the temperature of the cooling water at the inlet of the fuel cell stack 10 and the second temperature. The fuel cell system 1 may proceed to operation S130 when the temperature of the cooling water at the inlet of the fuel cell stack 10 is lower than or equal to the second temperature (S120-Yes). The fuel cell system 1 may proceed to operation S140 when the temperature of the cooling water at the inlet of the fuel cell stack 10 exceeds the second temperature (S120-No).

In operation S130, the controller 1000 may determine the starting method of the fuel cell system 1 as the cold start.

In operation S140, the controller 1000 may determine the starting method of the fuel cell system 1 as the normal start.

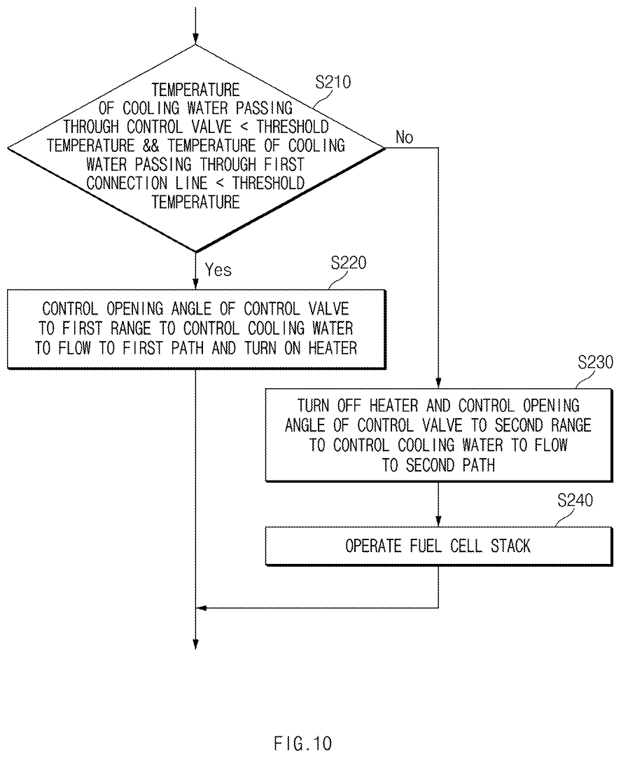

FIG. 10 is a flowchart for describing a process of controlling a control valve and a heater of the fuel cell system according to the embodiment disclosed in the present document.

Referring to FIG. 10, the fuel cell system 1 may control the flow path of the cooling water and the operation of the heater 50 during the cold start.

In operation S210, it may be compared whether the temperature of the cooling water passing through the control valve 20 is less than the threshold temperature and whether the temperature of the cooling water passing through the first connection line 130 is less than the threshold temperature. The fuel cell system 1 may proceed to operation S220 when the temperature of the cooling water passing through the control valve 20 is less than the threshold temperature and when the temperature of the cooling water passing through the first connection line 130 is less than the threshold temperature (S210-Yes). The fuel cell system 1 may proceed to operation S230 when the temperature of the cooling water passing through the control valve 20 is greater than or equal to the threshold temperature and when the temperature of the cooling water passing through the first connection line 130 is greater than or equal to the threshold temperature (S210-No).

In operation S220, the controller 1000 may control the opening angle of the control valve 20 to the first range to control the cooling water to flow through the first path and to control the heater 50 to be turned on.

In operation S230, the controller 1000 may turn off the heater 50 and control the opening angle of the control valve 20 to the second range to control the cooling water to flow through the second path.

In operation S240, the controller 1000 may operate the fuel cell stack 10.

A fuel cell system according to embodiments disclosed in the present document may effectively control a flow path of cooling water through one control valve when a fuel cell is started, and accordingly, may increase thermal management performance of the fuel cell and secure the safety of the fuel cell, a driver, and a passenger due to stable thermal management.

In addition, various effects directly or indirectly identified though the present specification may be provided.

Hereinabove, even though it has been described that all components constituting the embodiments disclosed herein are combined into one part or are operated while combined with each other, the embodiments disclosed herein are not necessarily limited to these embodiments. That is, all the components may be operated while selectively combined into one or more parts within the scope of the embodiments disclosed herein.

Further, terms such as “includes”, “constitutes”, or “have” described above mean that the corresponding component may be inherent unless otherwise stated, and thus should be construed as not excluding other components but further including other components. All terms including technical or scientific terms have the same meanings as those commonly understood by those skilled in the art to which the embodiments disclosed herein pertain unless otherwise defined. The generally used terms defined in the dictionaries should be construed as having the meanings that coincide with the meanings of the contexts of the related technologies, and should not be construed as ideal or excessively formal meanings unless clearly defined in the present disclosure.

The above description is merely illustrative of the technical spirit disclosed herein, and those skilled in the art to which the embodiments disclosed herein belong may make various modifications and changes without departing from the essential features of the embodiments disclosed herein. Thus, the embodiments disclosed herein are not intended to limit the technology spirit of the embodiments disclosed herein but are intended to describe the embodiments disclosed herein, and the scope of the technical spirit disclosed herein is not limited by these embodiments. The scope of protection of the technical spirit disclosed herein should be interpreted with reference to the appended claims, and all technical spirits within the scope equivalent thereto should be interpreted as being included in the scope of the present disclosure.

What is claimed is:

1. A fuel cell system comprising:
a fuel cell stack;
a control valve configured to control cooling water to flow to at least one of a first cooling line including the fuel cell stack and a radiator and a bypass line different from the first cooling line;
a heater configured to increase a temperature of the cooling water;
an ion filter configured to remove ions included in the cooling water; and
a controller configured to:
determine a starting method of a fuel cell based on an outside air temperature and the temperature of the cooling water at an inlet of the fuel cell stack, and
determine an opening angle of the control valve and an operation of the heater based on the temperature of the cooling water passing through the control valve and the temperature of the cooling water passing through a first connection line including the ion filter and connected to the first cooling line and the bypass line when the starting method is cold start.

2. The fuel cell system of claim 1, wherein the controller determines the starting method as the cold start in response to a determination that the outside air temperature is smaller than or equal to a first temperature and the temperature of the cooling water at the inlet of the fuel cell stack is smaller than or equal to a second temperature.

3. The fuel cell system of claim 2, wherein the controller controls the opening angle of the control valve to a first range, controls the cooling water to flow to a first path, and turns on the heater when the temperature of the cooling water passing through the control valve is smaller than a threshold temperature and the temperature of the cooling water passing through the first connection line is smaller than the threshold temperature.

4. The fuel cell system of claim 3, wherein the first path includes the first connection line, a second connection line including the heater, and the bypass line and does not include the first cooling line.

5. The fuel cell system of claim 2, wherein the controller turns off the heater, controls the opening angle of the control valve to a second range, and controls the cooling water to flow to a second path in response to a determination that the temperature of the cooling water passing through the control valve is greater than or equal to a threshold temperature or the temperature of the cooling water passing through the first connection line is greater than or equal to the threshold temperature.

6. The fuel cell system of claim 5, wherein the second path includes the first connection line and the first cooling line and does not include a second connection line including the heater.

7. The fuel cell system of claim 5, wherein the controller operates the fuel cell stack.

8. The fuel cell system of claim 1, wherein the ion filter and the control valve include a temperature sensor configured to obtain the temperature of the cooling water.

9. A thermal management method of a fuel cell system, the method comprising:
determining a starting method of a fuel cell based on an outside air temperature and a temperature of cooling water at an inlet of a fuel cell stack; and
determining an opening angle of a first valve and an operation of a heater which is configured to increase the temperature of the cooling water based on the temperature of the cooling water passing through a control valve and the temperature of the cooling water passing through a first connection line including an ion filter which is configured to remove ions included in the cooling water and connected to a first cooling line and a bypass line when the starting method is cold start,
wherein the control valve controls the cooling water to flow to at least one of the first cooling line including the fuel cell stack and a radiator and the bypass line different from the first cooling line.

10. The thermal management method of claim 9, wherein the determining of the starting method of the fuel cell based on the outside air temperature and the temperature of the cooling water at the inlet of the fuel cell stack includes determining the starting method as the cold start when the outside air temperature is smaller than or equal to a first temperature and the temperature of the cooling water at the inlet of the fuel cell stack is smaller than or equal to a second temperature.

11. The thermal management method of claim 9, wherein the determining the opening angle of the control valve and the operation of the heater includes:
comparing the temperature of the cooling water passing through the control valve and the temperature of the cooling water passing through the first connection line with a threshold temperature;
controlling the opening angle of the control valve to a first range, controlling the cooling water to flow to a first path, and turning on the heater when the temperature of the cooling water passing through the control valve is smaller than the threshold temperature and the temperature of the cooling water passing through the first connection line is smaller than the threshold temperature; and
turning off the heater, controlling the opening angle of the control valve to a second range, and controlling the cooling water to flow to a second path when the temperature of the cooling water passing through the control valve is greater than or equal to the threshold temperature or the temperature of the cooling water passing through the first connection line is greater than or equal to the threshold temperature.
